(19) United States
(12) Patent Application Publication
(10) Pub. No.: US 2003/0227473 A1
(43) Pub. Date: Dec. 11, 2003

(54) Real time incorporation of personalized audio into video game

(76) Inventors: Andy Shih, New York, NY (US); Brett T. Dorr, Cary, NC (US)

Correspondence Address: Kenneth M Goldman, 837 Ensenada Avenue, Berkeley, CA, 94707, US

(21) Appl. No.: 10/275,150

(22) PCT Filed: May 2, 2001
(86) PCT No.: PCT/US01/14106

(51) Int. Cl. G09G 5/00

(52) U.S. Cl. 345/716

(57) ABSTRACT

The present invention provides a computer method and system for incorporating user-personalized music and/or sound into a video game. In part, the invention relates to a music engine that interfaces with a video game, and provides a plurality of user-personalized sound files to the video game. The invention also relates to an encoded tag text files that identifies a user-personalized sound file to be played back at a specific point in a program.

### TECHNICAL FIELD

The present invention relates to a computer method and system for incorporating user-personalized music and/or sound into a video game.

### BACKGROUND OF THE INVENTION

Presently, the soundtrack architecture of most video games involves the use of discreet audio samples. Each video game has a pre-determined set of soundfiles (samples or songs) that defines all of the soundtrack possibilities within a game. The technical specifications and gameplay parameters of these sound files (e.g., file duration and deployment relative to stages of gameplay) are pre-set by the game developer. The current systems, therefore, require the user (i.e., video game player) to listen to the soundtrack chosen by the game developer, which either may not agree with the user, or eventually bore the user, or both.

There is therefore a need for a system that will permit a user to alter the soundtrack to suit the user's taste and/or prevent boredom.

### SUMMARY OF THE INVENTION

This invention solves the current problem with video games by providing a system and method that permits a user to incorporate user-personalized songs and sounds into a video game.

In one aspect of this invention, a method for incorporating user-personalized sound into a video game is provided, the method comprising: a) providing a music engine and an interface between the music engine and the video game, wherein the music engine is capable of providing a plurality of sound files to the video game, and further wherein the interface is capable of obtaining sound files from the music engine and presenting the sound files to the video game for playback; and b) sending a first signal from the video game to the interface to playback a first sound file from the music engine, thereby causing the music engine to send the first sound file to the video game for playback.

In another aspect of the invention, a video game apparatus capable of incorporating user-personalized sound is provided, the apparatus comprising: a) music engine means capable of accessing a plurality of sound files; b) interface means capable of obtaining sound files from the music engine and presenting the sound files for playback; c) trigger means for sending signals to the interface to playback sound files from the music engine; and d) playback means for playing sound files.

In yet another aspect of the invention, a sound file is provided, the sound file comprising a) data encoding a song or a sample, and b) a first encoded tag associated with the data containing information about how to use the data.

In a further aspect of the invention, an encoded tag text file for identifying a sound file to be played back is provided, the text file comprising: a) first data encoding the location of the sound file; b) second data encoding the duration of the sound file; c) third data encoding the instruction that triggers the playback of the sound file; and d) fourth data encoding information about the sound file.

In still another aspect of the invention, a computer program that incorporates playback of a sound file by means of an encoded tag text file associated with the sound file is provided, the program comprising: a) an instruction corresponding to an instruction in the encoded tag text file that triggers playback of the sound file; b) sound file retrieval means comprising means for obtaining location data for the sound file from the encoded tag text file; and c) sound file playback means comprising means for obtaining data from the encoded tag text file about where the beginning and endpoints of playback are.

In yet another aspect of the invention, a method of user-personalizing sound playback associated with a computer program is provided, the method comprising: a) generating a list of one or more events contained in the program to be associated with user-selected sound files; b) for each sound file selected by the user, prompting the user to generate an encoded tag text file associated with that sound file, the encoded tag text file comprising first data encoding the location of the sound file, second data encoding the duration of the sound file, third data encoding the instruction that triggers the playback of the sound file, and fourth data encoding information about the sound file; and c) using the generated encoded tag text files to playback the sound files.

### BRIEF DESCRIPTION OF THE FIGURES

FIG. 1 is a flow chart describing the path of execution of a music engine.

FIG. 2 is a flow chart describing the process of playing a sound file for a soundtrack or event.

FIG. 3 is a class diagram describing how a music engine is implemented.

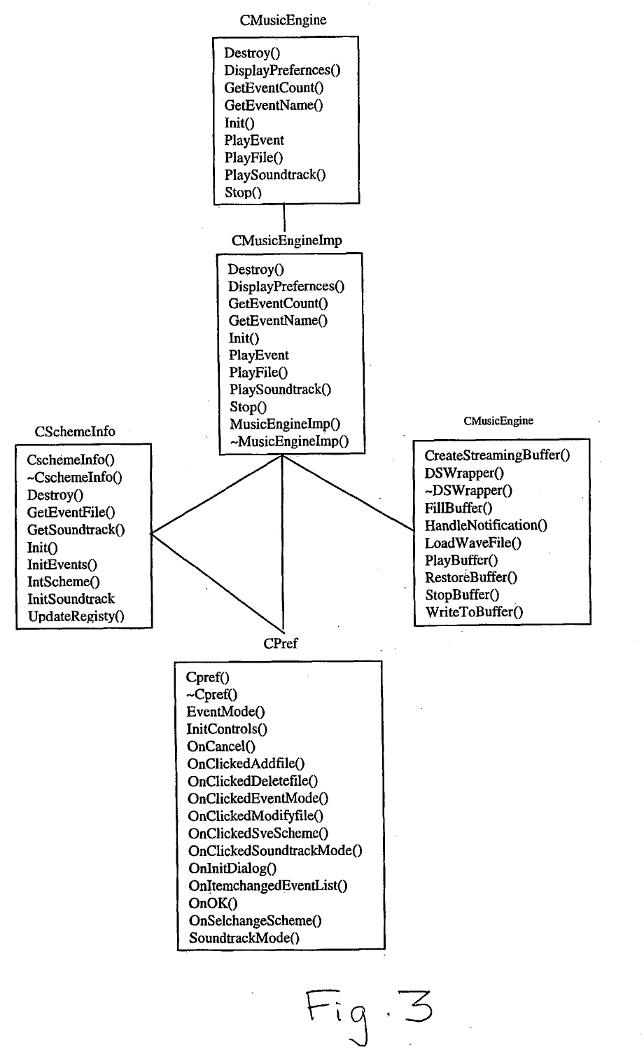

### DETAILED DESCRIPTION OF THE INVENTION

Definitions

“Music engine”, as used herein, refers to a device that functions as an intermediary audio controller between a media program, such as a video or computer game, and the operating platform for the media program, such as a personal computer or a video game console. Most often, the music engine is a software program.

“Interface”, as used herein, refers to the portion of the music engine that interacts with the outside. The music engine will have interfaces that interact with the media program, such as the video or computer game, with a set of sound files, and with a game player.

“User-personalized”, as used herein, refers to a capability of a media program, such as a video or computer game, to permit a user (such as a player of a video game or computer game) to change aspects of that program for personal preference. Particular aspects of the program that are user-personalized are the music and sounds associated with the program.

“Signal”, as used herein, refers to an electronic message sent by one part of a device that is recognized and responded to by another part of the device.

“Sound file”, as used herein, refers to an electronically stored data file which is capable of being read and played back as some type of sound. Typical sound files will encode samples or songs. “Song”, as used herein, refers to a piece of music. “Sample”, as used herein, refers to a portion of a song.

“Encoded tag”, as used herein, refers to an electronically stored piece of data that may be part of a sound file, or may be associated with a sound file, but is not played back as sound. Instead, the tag identifies one or more characteristics of the sound file, such as its title, function, duration, components, and the like, which helps the music engine determine when and how the sound file associated with the tag should be played back. The encoded tag may also contain information about its relationship to other encoded tags, or its relationship to programs that use the encoded tag to retrieve a sound file or files.

“Streaming”, as used herein, refers to a mode of playback of a sound file in which the sound file is loaded into a memory area in two or more sections, each succeeding section being loaded into a buffer before the previous section has finished playing back. Streaming playback may be used with sound files that are local (e.g., on the same device) or distant (e.g., on a network or on the internet). For example, a sound file may be “streamed” directly from a hard drive, or from a server on the internet.

In one type of internet or network-based streaming, the streaming playback is used to access “streaming audio”, which is basically a “radio station” on the internet or network. That is, a series of two or more songs are “streamed” sequentially from a single site, or “channel”. Often, like airwave-based radio stations, the songs on a single channel are related in some way, such as jazz, lite rock, or classical music.

The Music Engine

The music engine of the invention is a device that permits a media program, such as a video game, for example, to access virtually any type of sound file and insert it into a program at a defined or pre-arranged spot. In this fashion, the music engine allows user-personalized sounds or music to be incorporated into the media program. Preferably, the music engine is software, or a computer program. The music engine software may be written in any type of programming language. Preferably, the music engine software is written in a programming language that is capable of interacting with a multitude of other languages. The music engine must also interface with sound files. Preferably, the music engine software is programmed to be capable of interacting with a number of sound file formats, such as MP3, Liquid Audio, Red Book Audio, Realaudio, Windows Media, WAV, and the like

The preferable use of the music engine of the invention is in conjunction with a video or computer game. In this embodiment, the music engine is designed to interface with gaming platforms such as PC, Macintosh, Sony Playstation 1, Sony Playstation 2, Sega Dreamcast, Nintendo 64, Nintendo Game Cube, and Microsoft's X-Box. Browser- or internet-compatible music engines, or music engines interfaced with online single- or multi-player gaming are also encompassed. However, the music engine is also contemplated to be used with a variety of media programs, both known and yet to be employed. Without limitation, some other media programs that can interact with the music engine are: film, video, DVD and CD-ROMs.

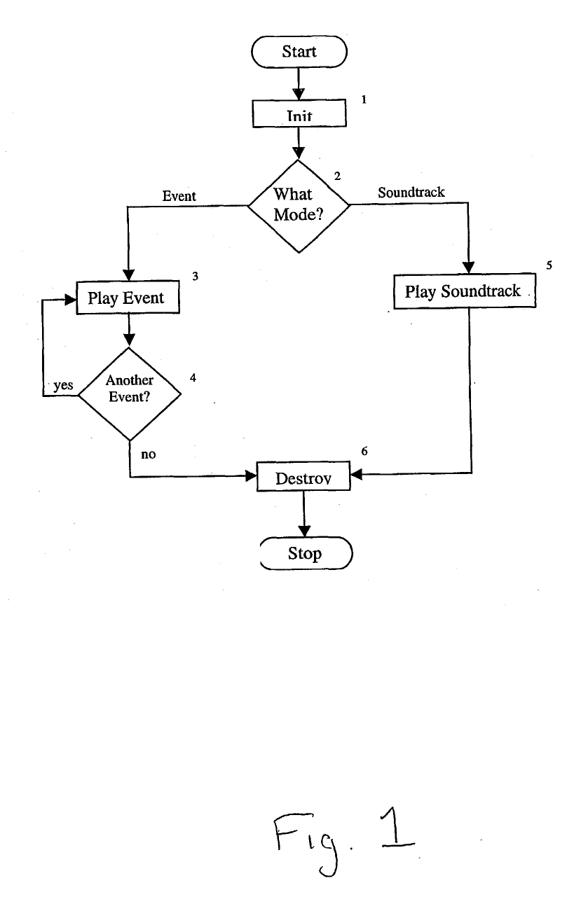

When a media program, such as a video game, uses the music engine, the music engine first runs an initialization 1 procedure as shown in FIG. 1. The initialization procedure sets up a sound playback system, such as DirectSound, for example, and a plurality of buffers so that sound files can be taken from the user source (e.g., a computer hard drive) and played back. The initialization procedure also obtains all necessary user-defined scheme information from a central location. This scheme information includes events that will be signaled, sound files associated with those events, and sound files associated if in soundtrack mode. The initialization also initiates a worker thread which services the buffers when sound files are being played.

The music engine then determines from the scheme information obtained whether it is playing in Event or Soundtrack mode 2. In Event mode, the engine will obtain an event number from the media program 3 and retrieve the appropriate event sound file and cause it to be played back. It will continue to receive subsequent event signals 4 and play them back until there are no more signaled events and a Destroy signal is received 6. The destroy command shuts down the sound playback system, and clears the buffers that are used to play the files. Any memory allocated for music playback or sound file storage is destroyed. The worker thread is also stopped since it is no longer needed.

In Soundtrack mode 5, a sound file containing a “song” comprising the soundtrack for the media program is retrieved by the engine, and played back until Destroy command 6 is received.

The music Engine also employs the following methods:

DisplayPreferences( )—This method creates a windows dialog that is used to change the sound files associated with certain events and soundtracks. When called, the method obtains all of the information that has been stored in the central location. Once a user confirms preferences by selecting “OK” in the dialog, then DiplayPreferences( ) will take the changed information and store it back in the central location.

GetEventCount( )—During initialization, the total number of Events that are registered for the game is stored. GetEventCount( ) simply returns the number of events that are used.

GetEventName( )—During initialization, each event is given a number and the name that is associated with that event. This method simply returns the name of an event for any given event number.

PlayEvent( )—This method takes in the number of the event to be played, and uses this number to locate the sound file associated with this event, as described in step 3 above. Once the file and filename is located, the music engine causes the sound file to be played back.

PlayFile( )—This method takes in a filename, locates it, and causes the sound file to be played back. This method is the same as PlayEvent( ) except it takes a filename rather than an event number.

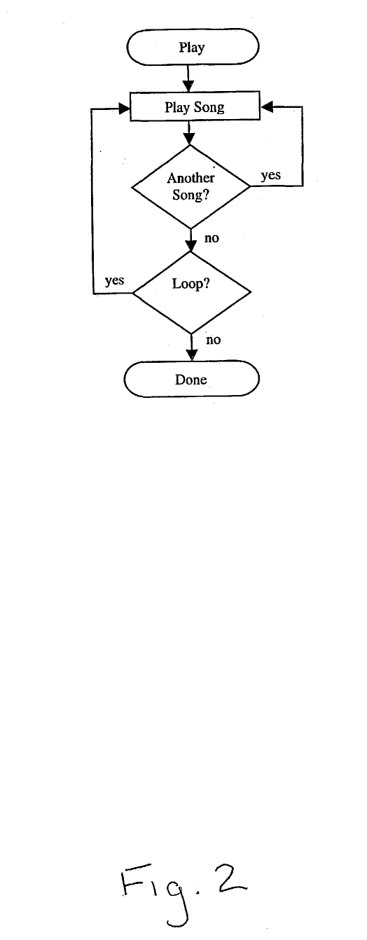

PlaySoundtrack( )—This method opens the first file that is in the soundtrack and causes the sound file to be played back. Once the first file is done playing, then the next file in the soundtrack list is opened and played. The engine will follow a protocol such as that shown in FIG. 2.

Stop( )—This method closes an opened sound file and tells DirectSound to stop playing the file.

The music engine of the invention causes sound files to be played back. Sound files may be played back in a variety of fashions. Samples (typically shorter fragments of sound or music, or pieces of songs) may be played back once, from beginning to end, or may be “looped” (played back repeatedly over and over without interruption). Songs (longer pieces of music) may also be played back once or looped. Songs or samples may also be played back, starting at a point other than the beginning, and may be looped to repeat a portion less than the entirety of the sound file. Such techniques may be accomplished with the use of encoded tags.

Encoded Tags

Encoded tags are used in a sound file to help the music engine recognize the identity of the sound file and match it with the corresponding sound file play command issued from the media program. Tags can identify the beginning and end of playback, and where, if any, “looped” playback should begin and end. Tags can also specify the following information associated with a sound file: 1) game title; 2) platform; and 3) where in the media program to play back the file.

Basically the encoded tag is a text file comprising data. The data in the text file may include one or more of the following: location data, duration data, playback trigger data, and sound file data. Preferably, the encoded tag comprises at least location data and playback trigger data.

Location data includes data about where the associated sound file is located. For example it may contain the memory address on a local or network computer where the file is located, or the location on an internet website where the file is located. Additionally, the location data may optionally include a URL or hyperlink directing the user to an e-commerce site where the user could automatically purchase or access the content described in the sound file. Hyperlinks to other related material could also be included. The location data could also include time-sensitive URLs or hyperlinks that could serve as an “admission ticket”, that is, directing the user to a limited-time event, such as a live concert or webcast.

Duration data includes data about where in the sound file playback begins and ends and how long playback lasts. Accordingly, duration data may include the start time (point in the sound file where playback begins), end time (point in the sound file where playback ends), duration (distance from start time to end time) and loop information (whether the portion of the sound file is to be played once or repeatedly in a looped fashion).

Playback trigger data includes data that determines what type of program event triggers playback of the associated sound file. For example, playback trigger data may include the name of certain program events (e.g., “Introduction”), or in the case of a video game program, the name of certain video game events (e.g., “monster attack” or “health low”). Playback trigger data may also be gameworldlocation based. For example, the data may refer to certain “virtual” locations in the game world, such as a marketplace, or a club, or the player's home base. In this embodiment, the playback trigger data will trigger certain sound files when the virtual player arrives at certain virtual locations.

Sound file data includes data about the sound file. For example, sound file data may include file type (e.g., song, loop, sound), file program type (e.g., mp3, wav, etc.), file name (e.g., name of song and author/performer data).

Optionally, the encoded tag can also include effects processing data. Effects processing data comprise one or more instructions for processing the sound encoded by the sound file. Sound processing instructions include, for example, instructions for modifying the sound envelope (equalization, or EQ), and adding effects such as reverberation (reverb) and tremolo well known in the art. For example, effects processing data may instruct the music engine to play a sound file with additional “hall reverb” and a “jazz-like EQ”. Such processing can be accomplished by calling “effects plug-ins” that are custom made or commercially available.

With the tag system, a music engine only needs to find a given point in the file and instead of playing the file until it ends, play it for the duration that the tag specifies. A single sound file may be “tagged” in different sections as various “start” and “end” points for playback. Additionally, a group of two or more encoded tags may be assembled into encoded tag lists, optionally including the sound files associated with the encoded tags. An encoded tag list thus functions as a set of instructions for a game program, wherein the music engine will direct the playback of user-personalized sound files with specific game events or locations.

Encoded Tag Generator

A user may also utilize a computer program to aid in the generation of encoded tags. This computer program, an “encoded tag generator”, will take an initial computer program, and generate a list of one or more events contained in the program to be associated with user-selected sound files. Then, for each such generated event, the encoded tag generator will prompt the user to identify a sound file to be associated with the event. The generator will then create one or more encoded tag for each event, comprising location data, duration data, playback trigger data and sound file data. The generator then provides the created encoded tags, so that the initial computer program will now run using the user-selected sound files during playback.

The encoded tag generator may be used with a wide range of initial computer programs. Such programs comprise: video games, film, broadcasted content such as TV or radio, DVD, video, VCD, CD-ROM, or any programs that align or assemble a final media product where multiple content elements (sound, image, text, etc.) are arranged according to editorial instructions to play as a complete and cohesive whole.

What is claimed is:

1. An encoded tag text file for identifying a sound file to be played back, the text file comprising:
a) first data encoding the location of the sound file; and
b) second data encoding the instruction that triggers the playback of the sound file.

2. The encoded tag text file of claim 1, further comprising:
c) third data encoding the duration of the sound file.

3. The encoded tag text file of claim 2, further comprising:
d) fourth data encoding information about the sound file.

4. The encoded tag text file of claim 2 wherein the third data includes a start time and an end time located in the sound file.

5. The encoded tag text file of claim 1 wherein the second data is an event.

6. The encoded tag text file of claim 3 wherein said fourth data includes one or more data selected from the group consisting of file type, file name and file author.

7. A sound file comprising:
a) data encoding a song or a sample, and
b) the encoded tag text file of claim 1 associated with the data.

8. A computer program that incorporates playback of a sound file by means of an encoded tag text file associated with the sound file, the program comprising:
a) an instruction corresponding to an instruction in the encoded tag text file that triggers playback of the sound file;
b) sound file retrieval means comprising means for obtaining location data for the sound file from the encoded tag text file; and
c) sound file playback means comprising means for obtaining data from the encoded tag text file about where the beginning and endpoints of playback are.

9. A method of user-personalizing sound playback associated with a computer program, the method comprising:
a) generating a list of one or more events contained in the program to be associated with user-selected sound files;
b) for each sound file selected by the user, prompting the user to generate an encoded tag text file associated with that sound file, the encoded tag text file comprising first data encoding the location of the sound file, second data encoding the instruction that triggers the playback of the sound file, third data encoding the duration of the sound file, and fourth data encoding information about the sound file; and
c) using the generated encoded tag text files to playback the sound files.

10. The method of claim 9, wherein in step b), the third data is generated by playing back the sound file in real time and prompting the user to specify the beginning and endpoints of playback by signaling said endpoints in real time.

11. The method of claim 10 wherein the signaling is accomplished by depressing a keyboard key.

12. A method for incorporating user-personalized sound into a video game, the method comprising:
a) providing a music engine and an interface between the music engine and the video game, wherein the music engine is capable of providing a plurality of sound files to the video game, and further wherein the interface is capable of obtaining sound files from the music engine and presenting the sound files to the video game for playback;
b) sending a first signal from the video game to the interface to playback a first sound file from the music engine, thereby causing the music engine to send the first sound file to the video game for playback.

13. The method of claim 12, further comprising:
c) sending a second signal from the video game to the interface to playback a second sound file from the music engine, thereby causing the music engine to send the second sound file to the video game for playback.

14. The method of claim 12 wherein the first sound file comprises:
a) a first encoded tag text file, and
b) a song or a sample.

15. The method of claim 12 wherein in step b), the video game playback is accomplished by streaming audio.

16. A video game apparatus capable of incorporating user-personalized sound, the apparatus comprising:
a) music engine means capable of accessing a plurality of sound files;
b) interface means capable of obtaining sound files from the music engine and presenting the sound files for playback;
c) trigger means for sending signals to the interface to playback sound files from the music engine; and
d) playback means for playing sound files.

17. The apparatus of claim 16 further comprising: a plurality of sound files.

18. The apparatus of claim 16 wherein the playback means is capable of playing sound files by streaming audio.

19. The apparatus of claim 18 wherein the playback means is capable of playing sound files by streaming audio from the internet.

20. The apparatus of claim 16 wherein the playback means is capable of playing sound files in a looped fashion.
